(19) United States
(12) Patent Application Publication
(10) Pub. No.: US 2023/0421560 A1
(43) Pub. Date: Dec. 28, 2023

(54) OPERATION APPARATUS, OPERATION METHOD, AND PROGRAM

(71) Applicant: NEC Corporation, Tokyo (JP)

(72) Inventors: Takahiro Mizuta, Tokyo (JP); Tetsuya Tanabiki, Tokyo (JP); Tetsuro Hasegawa, Tokyo (JP); Eiichi Tokumi, Tokyo (JP)

(73) Assignee: NEC Corporation, Tokyo (JP)

(21) Appl. No.: 18/208,073

(22) Filed: Jun. 9, 2023

(30) Foreign Application Priority Data
Jun. 27, 2022 (JP) 2022-103015

(51) Int. Cl. H04L 9/40

(52) U.S. Cl. CPC H04L 63/101; H04L 63/107; H04L 63/0823; H04L 63/108

(57) ABSTRACT

An operation apparatus includes a permission information acquisition unit, a certification information generation unit, and a transmission unit. The permission information acquisition unit acquires permission information indicating that an operator is permitted to operate the predetermined moving object. The certification information generation unit generates certification information based on the received permission information and information for specifying the operator. The transmission unit transmits the certification information so as to be recognizable by another person via a predetermined communication line.

### INCORPORATION BY REFERENCE

This application is based upon and claims the benefit of priority from Japanese patent application No. 2022-103015, filed on Jun. 27, 2022, the disclosure of which is incorporated herein in its entirety by reference.

### TECHNICAL FIELD

The present disclosure relates to an operation apparatus, an operation method, and a program.

### BACKGROUND ART

The use of drones (also referred to as an unmanned aircraft, an unmanned aerial vehicle (UAV), or the like.) is expanding. Along with this, proposals for smoothly utilizing drones have been made.

For example, Published Japanese Translation of PCT International Publication for Patent Application, No. 2019-530067 discloses a system that uniquely identifies various components (UAV or the like) interacting with an interested party (user, owner, or the like) and supports registration, management, and authentication of the components for the interested party.

Published Japanese Translation of PCT International Publication for Patent Application, No. 2017-532237 discloses a technique for confirming a UAV and user identification information using an authentication system and providing secure communication between a user and the UAV.

Japanese Unexamined Patent Application Publication No. 2018-032201 discloses a technique of performing authentication of a combination of a registered account identifier and a password in response to an authentication request of the combination in which the combination is specified.

Japanese Unexamined Patent Application Publication No. 2016-173722 discloses a technique of storing operation permission information received from a drone operation management means, receiving desired movement route information from an operation terminal, and transmitting movement route information determined that the desired movement route information conforms to the operation permission information to the drone.

### SUMMARY

By the way, in a case where a drone is operated, there is a case where a person (that is, an operator) who operates the drone is required to have permission for operation in advance from, for example, a predetermined organization, group, local government, or the like. However, even when the operator is permitted or legally operating the drone, there is no way to objectively determine whether it is legal.

In view of the above-described problems, an example object of the invention is to provide is to provide an operation apparatus, an operation method, and a program that can objectively notify that a drone is officially operated.

In a first example aspect, an operation apparatus according to the present disclosure includes a permission information acquisition unit, a certification information generation unit, and a transmission unit. The permission information acquisition unit acquires permission information indicating that an operator is permitted to operate the predetermined moving object. The certification information generation unit generates certification information based on the received permission information and information for specifying the operator. The transmission unit transmits the certification information so as to be recognizable by another person via a predetermined communication line.

In a second example aspect, an operation method according to the present disclosure executed by an operation apparatus of an operator who operates a predetermined moving object includes the following method. The operation apparatus acquires permission information indicating that permission is obtained for operating the moving object. The operation apparatus generates certification information based on the received permission information and information for specifying the operator. The operation apparatus transmits the certification information so as to be recognizable by another person via a predetermined communication line.

In a third example aspect, a program according to the present disclosure causes an operation apparatus of an operator who operates a predetermined moving object to execute the following operation method. The operation apparatus acquires permission information indicating that permission is obtained for operating the moving object. The operation apparatus generates certification information based on the received permission information and information for specifying the operator. The operation apparatus transmits the certification information so as to be recognizable by another person via a predetermined communication line.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram of an operation apparatus according to a first example embodiment;

FIG. 2 is a flowchart of an operation method according to the first example embodiment;

FIG. 3 is a system configuration diagram including an operation apparatus according to a second example embodiment;

FIG. 4 is a block diagram of the operation apparatus according to the second example embodiment;

FIG. 5 is a block diagram of a terminal of another person according to the second example embodiment;

FIG. 6 is a diagram illustrating permission information;

FIG. 7 is a diagram illustrating certification information;

FIG. 8 is a first diagram illustrating an example of display of the certification information;

FIG. 9 is a second diagram illustrating the example of display of the certification information;

FIG. 10 is a system configuration diagram including an operation apparatus according to a third example embodiment;

FIG. 11 is a block diagram of an operation apparatus according to a third example embodiment;

FIG. 12 is a block diagram of a permission apparatus according to the third example embodiment;

FIG. 13 is a sequence diagram executed by the operation apparatus and the permission apparatus according to the third example embodiment;

FIG. 14 is a sequence diagram executed by the operation apparatus and a terminal of another person according to the third example embodiment; and

FIG. 15 is a block diagram illustrating a hardware configuration of a computer.

### EXAMPLE EMBODIMENTS

Hereinafter, the present disclosure will be described through example embodiments of the disclosure, but the disclosure according to the claims is not limited to the following example embodiments. In addition, not all the configurations described in the example embodiments are essential as means for solving the problem. For clarity of description, the following description and drawings are omitted and simplified as appropriate. In each drawing, the same elements are denoted by the same reference numerals, and redundant description is omitted as necessary.

### First Example Embodiment

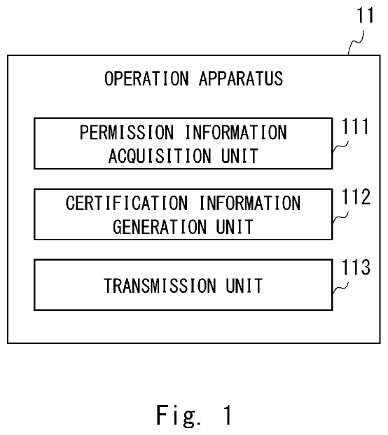

Hereinafter, example embodiments of the present disclosure will be described with reference to the drawings. FIG. 1 is a block diagram of an operation apparatus according to a first example embodiment. An operation apparatus 11 illustrated in FIG. 1 is an apparatus for operating a predetermined moving object. The moving object in the present disclosure is, for example, a moving object that moves by remote control or a moving object that autonomously moves under predetermined control. More specifically, the moving object may include an unmanned aerial vehicle, an autonomous driving vehicle, an autonomous mobile robot, a ship, a construction vehicle, and a walking robot that move by remote control or autonomous movement, and the like.

The operation apparatus 11 has a function of indicating to another person that a person who operates a moving object is operating the moving object with permission. The operation apparatus 11 mainly includes a permission information acquisition unit 111, a certification information generation unit 112, and a transmission unit 113. The operation apparatus 11 may have a function of controlling the moving object.

The permission information acquisition unit 111 acquires permission information indicating that an operator is permitted to operate a predetermined moving object. The permission information is issued from a jurisdiction or the like that has jurisdiction over the operation of the moving object in a space where the moving object moves. The permission information may include information about a time, a place, and an operator related to the operation. The permission information may include airframe information for identifying a moving object related to the operation. For example, the permission information acquisition unit 111 may acquire the permission information from a permission apparatus managed by the above jurisdiction through a communication line. Alternatively, the permission information acquisition unit 111 may acquire the permission information via a predetermined non-volatile information medium.

The certification information generation unit 112 generates certification information. The certification information is information for proving to another person that the operator is officially permitted to operate the moving object. That is, the certification information includes contents that allow the another person to recognize that the operator is officially permitted to operate the moving object. Thus, the certification information includes at least part of the permission information. Further, the certification information includes information for specifying the operator.

The information specifying the operator may include, for example, a name or a predetermined unique identifier of the operator. The information for specifying the operator may include information about a position where the operator currently exists. The information for specifying the operator may include information for associating the operator with the operation apparatus 11. Further, the information for specifying the operator may be information for specifying the operation apparatus 11.

The transmission unit 113 transmits the certification information so as to be recognizable by another person via a predetermined communication line. The predetermined communication line may be wired or wireless. In addition, the predetermined line may be a line that connects the communication terminals to each other so as to enable direct communication, or may be a line that allows another person to access the certification information via a predetermined network.

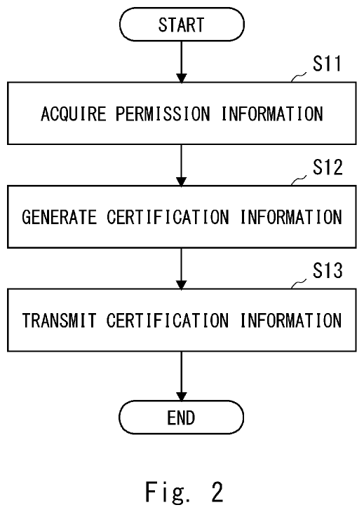

Next, processing executed by the operation apparatus 11 will be described with reference to FIG. 2. FIG. 2 is a flowchart of an operation method according to the first example embodiment. The processing illustrated in FIG. 2 may be executed by an operation of an operator using the operation apparatus 11, for example.

First, the permission information acquisition unit 111 of the operation apparatus 11 acquires permission information indicating that permission is obtained for operating the moving object from a predetermined permission apparatus (Step S11). The permission information acquisition unit 111 supplies the acquired permission information to the certification information generation unit 112.

Next, the certification information generation unit 112 generates the certification information from the permission information received from the permission information acquisition unit 111 and the information for specifying the operator (Step S12). After generating the certification information, the certification information generation unit 112 supplies the generated certification information to the transmission unit 113.

Next, the transmission unit 113 transmits the certification information received from the certification information generation unit 112 (Step S13). At this time, the transmission unit 113 transmits the certification information so that another person can recognize the certification information. When transmitting the certification information, the operation apparatus 11 ends series of processing.

The processing executed by the operation apparatus 11 has been described above. Through the above processing, another person can recognize that the operator is officially permitted to operate the moving object. As a result, the user of the operation apparatus 11 can smoothly operate the moving object. Step S13 may be repeatedly executed.

The operation apparatus according to the first example embodiment has been described above. Note that the operation apparatus 11 includes a processor and a storage device as components (not illustrated). The storage device included in the operation apparatus 11 includes, for example, a storage device including a non-volatile memory such as a flash memory or a solid state drive (SSD). In this case, the storage device included in the operation apparatus 11 stores a computer program (hereinafter, the program is also simply referred to as a program) for executing the above-described method. In addition, the processor reads a computer program from the storage device into a buffer memory such as a dynamic random access memory (DRAM), and executes the program.

Each configuration of the operation apparatus 11 may be realized by dedicated hardware. In addition, some or all of the components may be realized by general-purpose or dedicated circuitry, a processor, or the like, or a combination thereof. These may be configured by a single chip or may be configured by a plurality of chips connected via a bus. A part or all of each component of each device may be realized by a combination of the above-described circuit or the like and a program. Furthermore, as the processor, a central processing unit (CPU), a graphics processing unit (GPU), a field-programmable gate array (FPGA), or the like can be used. Note that the description regarding the configuration described here can also be applied to other devices or systems described below in the present disclosure.

In addition, in a case where some or all of the components of the operation apparatus 11 are realized by a plurality of operation apparatuses, circuits, and the like, the plurality of operation apparatuses, circuits, and the like may be arranged in a centralized manner or in a distributed manner. For example, the operation apparatus, the circuit, and the like may be realized as a form in which each of the operation apparatus, the circuit, and the like is connected via a communication network, such as a client server system and a cloud computing system. Furthermore, the function of the operation apparatus 11 may be provided in a software as a service (SaaS) format. The foregoing methods may also be stored in a computer-readable medium for causing a computer to perform the foregoing methods.

The permission information and the certification information may include a predetermined electronic encryption, token, or non-fungible token (NFT). As a result, the operation apparatus 11 can indicate to another person that the certification information is proper.

As described above, according to the present example embodiment, it is possible to provide an operation apparatus and the like capable of objectively notifying that the moving object is officially in operation.

### Second Example Embodiment

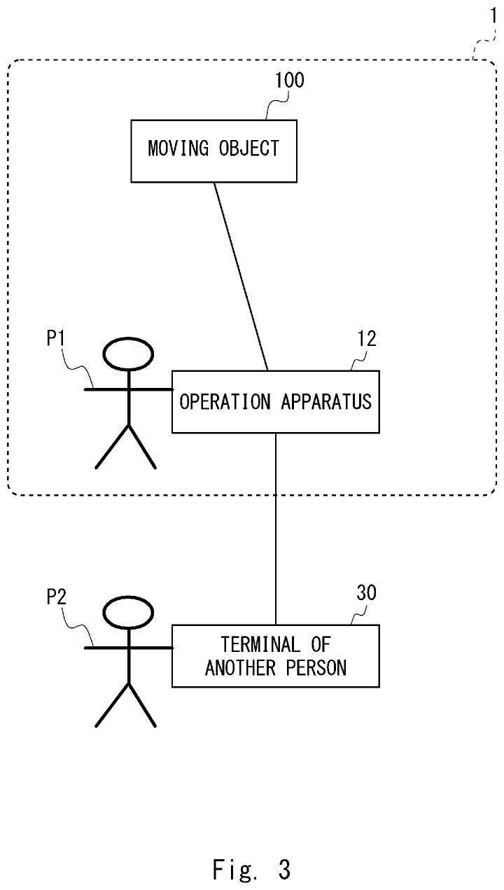

Next, an operation apparatus will be described with reference to FIG. 3. FIG. 3 is a configuration diagram of an operation system 1 including an operation apparatus according to the second example embodiment. The operation system 1 includes an operation apparatus 12 and a moving object 100. The operation apparatus 12 is wirelessly communicably connected to the moving object 100 and controls the moving object 100. An operator P1 of the moving object 100 possesses the operation apparatus 12 and operates the operation apparatus 12 to operate the moving object 100.

In addition, the operation apparatus 12 can transmit the certification information to a terminal of another person. At this time, a frequency band of a radio wave for controlling the moving object 100 and a frequency band for transmitting the certification information to the terminal of the another person may be the same or different. The frequency band used by the operation apparatus 12 is, for example, a 2.4 gigahertz band. The operation apparatus 12 may transmit a signal for controlling the moving object 100 including the certification information. Alternatively, the operation apparatus 12 may transmit the certification information from a channel different from the signal for controlling the moving object 100.

A terminal 30 of the another person is a computer with a wireless communication function possessed by a user P2 who is the another person. The terminal 30 of the another person is more specifically, for example, a smartphone, a mobile phone, a tablet terminal, or the like. The terminal 30 of the another person is configured to be able to receive a signal transmitted by the operation apparatus 12.

In the above-described configuration, the operator P1 operates the moving object 100 in accordance with the condition for which the permission is received. At this time, the operator P1 controls the moving object 100 and transmits certification information indicating that the operator P1 is permitted to operate the moving object 100. The terminal 30 of the another person possessed by a user P2 receives a signal transmitted by the operation apparatus 12 and reads the certification information from the received signal. Further, the terminal 30 of the another person displays the read certification information so that the user P2 can recognize the read certification information. As described above, in the operation system 1, the operator P1 who operates the moving object 100 can transmit the certification information and cause the user P2 to recognize the certification information.

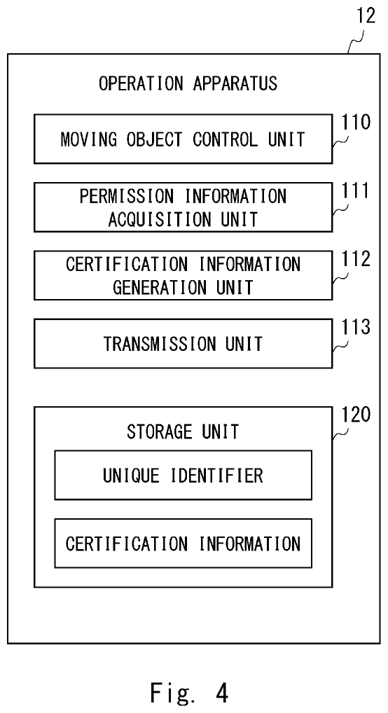

Next, the operation apparatus 12 will be further described with reference to FIG. 4. FIG. 4 is a block diagram of the operation apparatus according to the second example embodiment. The operation apparatus 12 mainly includes a moving object control unit 110, a permission information acquisition unit 111, a certification information generation unit 112, a transmission unit 113, and a storage unit 120.

The moving object control unit 110 controls the moving object 100. The moving object control unit 110 may include an operation reception unit for the operator P1 to operate the moving object or a transmitter that transmits a signal related to the received operation to the moving object 100.

The permission information acquisition unit 111 acquires permission information. The permission information acquisition unit 111 may acquire the permission information from a permission apparatus managed by a predetermined jurisdiction or the like via a communication line. Alternatively, the permission information acquisition unit 111 may acquire the permission information via a predetermined non-volatile information medium. When acquiring the permission information, the permission information acquisition unit 111 stores the acquired permission information in the storage unit 120.

The certification information generation unit 112 generates certification information. When generating the certification information, the certification information generation unit 112 according to the present example embodiment uses a unique identifier and the certification information stored in the storage unit. The unique identifier may be associated with the airframe information of the moving object. The unique identifier may mean a unique identifier of the own device or may mean a unique identifier of the operator P1 who uses the operation apparatus 12. Here, the “own device” indicates the operation apparatus 12 itself.

The transmission unit 113 transmits the certification information so as to be recognizable by another person via a predetermined communication line. The predetermined communication line according to the present example embodiment can directly transmit the certification information to a terminal held by another person, for example. More specifically, the communication line used by transmission unit 113 may be Bluetooth (registered trademark). The communication line used by transmission unit 113 may be Wi-Fi Direct, Wi-Fi Aware, or Wi-Fi Beacon using Wi-Fi. Furthermore, the communication line used by the transmission unit 113 may conform to other communication standards capable of realizing the above-described functions.

The transmission unit 113 according to the present example embodiment may control transmission of the certification information according to the content of the certification information. For example, the transmission unit 113 may transmit the certification information regarding the permission within a time (within a permitted time) when the operation is permitted, and may suppress the transmission of the certification information regarding the permission for a time (outside the permitted time) other than the time when the operation is permitted.

Furthermore, for example, the transmission unit 113 may transmit the certification information regarding the permission in a case where the operation apparatus 12 exists in an area (permitted area) in which the operation is permitted, and may suppress the transmission of the certification information regarding the permission in a case where the operation apparatus 12 exists outside the area (outside the permitted area) in which the operation is permitted.

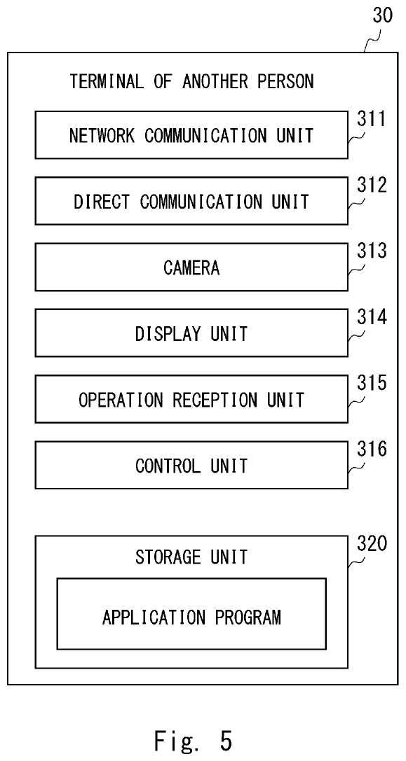

Next, the terminal 30 of the another person will be described with reference to FIG. 5. FIG. 5 is a block diagram of the terminal 30 of the another person according to the second example embodiment. The terminal 30 of the another person mainly includes a network communication unit 311, a direct communication unit 312, a camera 313, a display unit 314, an operation reception unit 315, a control unit 316, and a storage unit 320.

The network communication unit 311 has a function of connecting to a predetermined network line. The network line to which the network communication unit 311 is connected is, for example, the Internet, Ethernet, a public telephone line, or the like. The network communication unit 311 may include an antenna for connection to a network line, a circuit for encryption or decryption, and the like.

The direct communication unit 312 has a function for realizing communication with other devices capable of predetermined direct communication. The direct communication may be, for example, Bluetooth (registered trademark), Wi-Fi Direct using Wi-Fi, Wi-Fi Aware, or Wi-Fi Beacon. The direct communication may conform to other communication standards capable of directly communicating with other devices. The direct communication unit 312 may include an antenna, a transmission/reception circuit, and the like for communicating with other devices.

The direct communication unit 312 according to the present example embodiment receives the certification information transmitted from the operation apparatus 12. Upon receiving the certification information, the direct communication unit 312 supplies the received information to the control unit 316.

The camera 313 photographs a landscape outside the terminal 30 of the another person and generates image data regarding an image of the photographed landscape. The camera 313 includes an objective lens, an imaging element, an image processing circuit, and the like.

The display unit 314 is a display device for presenting various types of information to the terminal 30 of the another person. The display unit 314 includes a liquid crystal panel or an organic electroluminescence.

The operation reception unit 315 receives an operation from a user who uses the terminal 30 of the another person. The operation reception unit 315 can include, for example, a button, a switch, a touch sensor, and the like. The operation reception unit 315 may be a touch panel superimposed on the display unit 314 and function in cooperation with the display unit 314.

The control unit 316 appropriately receives a signal from each component of the terminal 30 of the another person, processes the received signal, and issues an instruction to each component. The control unit 316 includes an arithmetic device such as a central processing unit (CPU) or a micro controller unit (MCU). The control unit 316 starts an application program stored in the storage unit 320 and executes predetermined processing according to the application program. As one specific process, when receiving the certification information from the operation apparatus 12, the control unit 316 displays the received certification information.

The storage unit 320 is a storage device including a non-volatile memory such as a solid state drive (SSD) or a flash memory. The storage unit 320 stores at least a predetermined application program. The predetermined application program is a program for displaying the certification information received from the operation apparatus 12.

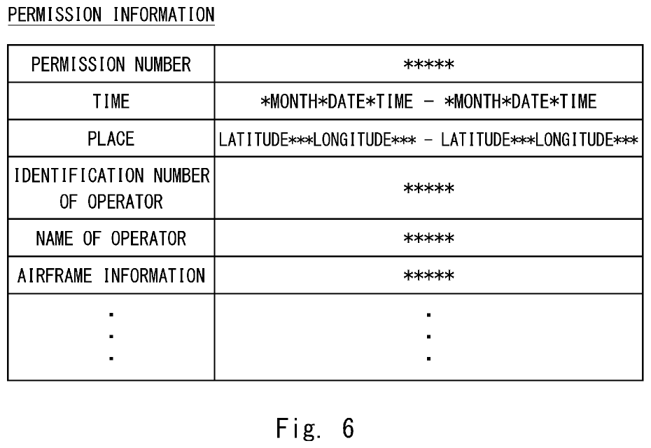

Next, the permission information will be described with reference to FIG. 6. FIG. 6 is a diagram illustrating the permission information. The permission information illustrated in FIG. 6 includes a permission number, a time, a place, an identification number of an operator, a name of the operator, airframe information, and the like.

The permission number is a number assigned to each piece of permission information by a jurisdiction or the like that manages permission or non-permission of operation. The time is an operation time required for permission, and includes, for example, an operation start time and an operation end time. That is, the permitted operator can operate the moving object in a period between the operation start time and the operation end time.

The place is information indicating an operation place related to permission. FIG. 6 illustrates latitude and longitude of two points. In this case, as a place where the operation is permitted, a place related to the permission is defined by a region defined by a rectangle having a line connecting two points as a diagonal line. Note that the place may be defined by a name of the place or may be defined by a preset section. The place may include an altitude. The place may include information on a place where operation is prohibited.

The identification number of the operator is, for example, a number for specifying the operator. The name of the operator may be the name of the operator as an individual, or may be the name of the operator as a corporation. The airframe information may include an identification number of the airframe related to the operation, a model name, or other functions and performances related to permission of the operation.

Although the permission information has been described above, the permission information is not limited to the above contents. The permission information may include a plurality of times and places required for permission. For example, the permission information may vary in place for each time. The permission information may include a remote ID (ID=Identifier).

The remote ID is information for identifying a moving object such as a drone from a distant place. The remote ID may include, for example, a registration symbol, a manufacturing number, position information, time, and the like as information that can identify the moving object. Furthermore, the remote ID is not limited to these pieces of information, and may include information indicating an operation state of the moving object.

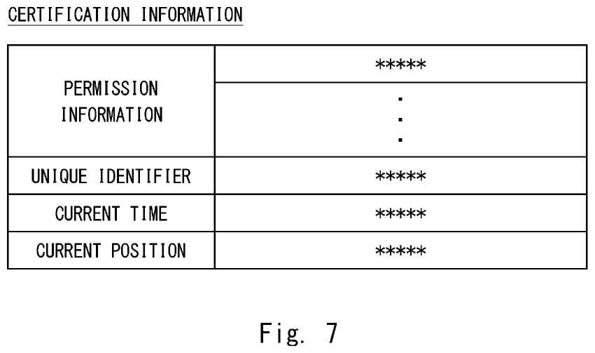

Next, the certification information will be described with reference to FIG. 7. FIG. 7 is a diagram illustrating the certification information. The certification information may include at least a portion of the permission information. For example, the certification information may include a permitted time and a permitted place of operation.

The certification information includes a unique identifier in addition to the permission information. The unique identifier is information for specifying the operation apparatus 12. The unique identifier may include the airframe information of the moving object and the identification information of the operator.

The certification information may also include information about a current time and a current position. The current time is a time at a time point when the certification information is generated. The current position is a position at the time of generating the certification information, and indicates, for example, latitude, longitude, and altitude.

An example of the certification information has been described above. The operation apparatus 12 may transmit the certification information while updating the certification information every predetermined period.

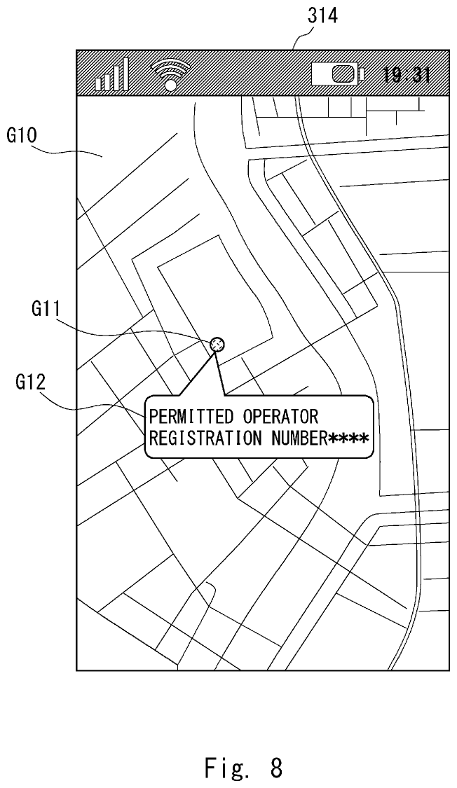

Next, an example of a display mode of the certification information will be described with reference to FIG. 8. FIG. 8 is a first diagram illustrating an example of display of the certification information. FIG. 8 illustrates the display unit 314 of the terminal 30 of the another person. The display unit 314 displays a map image G10. The map image G10 includes an icon G11 and an information display G12.

The icon G11 is an icon indicating a predetermined point on the map. The icon G11 indicates the position of the operator P1 included in the certification information received by the terminal 30 of the another person.

The information display G12 displays character information of at least a part of the certification information associated with the icon G11. For example, the information display G12 illustrated in FIG. 8 displays information of “permitted operator” and “registration number ***”.

Thus, the terminal 30 of the another person displays the position of the operation apparatus 12 on the display unit 314 of the terminal 30 of the another person from the position information of the operation apparatus 12 included in the certification information. The terminal 30 of the another person can display predetermined information included in the certification information acquired from the operation apparatus 12 on the display unit 314. The user P2 who uses the terminal 30 of the another person can recognize the position where the operator P1 exists by visually recognizing the display unit 314. In addition, the user P2 can recognize that the operator P1 is a person who is officially permitted to operate the moving object.

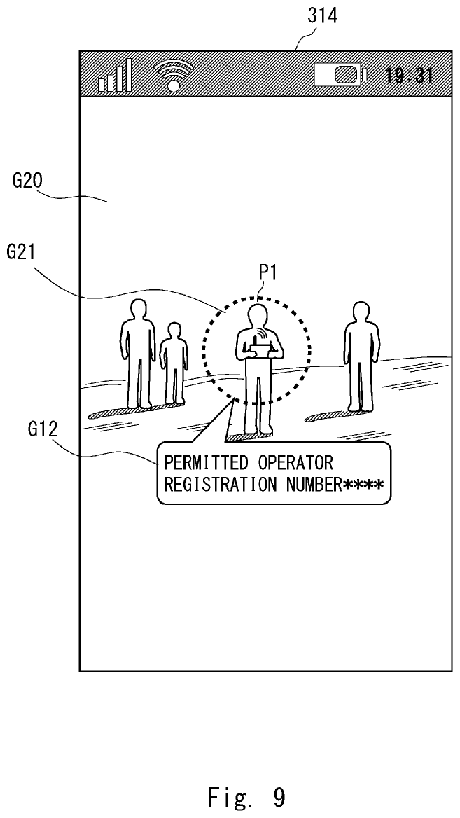

Next, a display mode of the certification information will be further described with reference to FIG. 9. FIG. 9 is a second diagram illustrating an example of display of the certification information. The display unit 314 illustrated in FIG. 9 displays a camera image G20 in which predetermined information is superimposed on an image photographed by the camera 313 of the terminal 30 of the another person. The operator P1 is displayed at the center of the camera image G20. In other words, the camera image G20 indicates that the user P2 is in a state of photographing the operator P1 by the camera 313 of the terminal 30 of the another person.

The camera image G20 includes an icon G21 and an information display G12. The icon G21 is an image superimposed on a position where the operation apparatus 12 is estimated to be present in the camera image G20 obtained by photographing a direction in which the operation apparatus 12 is present. The terminal 30 of the another person displays the position of the operation apparatus 12 on the display unit 314 of the terminal 30 of the another person by associating the position of the operation apparatus 12 included in the certification information with the posture of the terminal 30 of the another person. An icon G21 illustrated in FIG. 9 is a circle drawn by a dotted line. This indicates that the operation apparatus 12 exists in the range of the circle on the icon G21.

At this time, for example, the terminal 30 of the another person may measure the strength of the radio wave including the certification information, and set the position, size, and the like of the icon G21 according to the measured radio wave strength. For example, the terminal 30 of the another person may display the circle displayed as the icon G21 with a larger diameter as the radio field intensity is relatively higher, and display the circle displayed as the icon G21 with a smaller diameter as the radio field intensity is relatively lower.

As described above, the terminal 30 of the another person may superimpose and display, on the display unit 314, the image obtained by photographing the landscape in the direction in which the terminal of the another person exists and the position of the operation apparatus 12. With this display, the terminal 30 of the another person can allow the user P2 to intuitively grasp the position of the operator.

Note that, in the example of FIG. 9, the terminal 30 of the another person may perform predetermined processing on the display of the person instead of displaying the photographed image as it is. More specifically, for example, the terminal 30 of the another person may detect an image of a person included in the camera image G20 and superimpose an alternative image such as a predetermined avatar on the detected image of the person. As a result, the terminal 30 of the another person can display necessary information to the user P2 while considering the privacy of the operator P1 who is being photographed.

Although the second example embodiment has been described above, the operation apparatus 12 according to the second example embodiment is not limited to the above-described configuration. For example, the operation apparatus 12 may not be integrated with the moving object control unit 110.

The above-described operation apparatus 12 can cause predetermined another person to recognize the certification information. When the user P2 who is the another person has the terminal 30 of the another person, the user P2 can recognize the presence of the operator of the moving object. As a result, both the operator P1 of the moving object and the user P2 who is the another person can eliminate the anxiety concerning the operation of the moving object 100. As described above, according to the second example embodiment, it is possible to provide the operation apparatus and the like capable of objectively notifying that the drone is officially operated.

### Third Example Embodiment

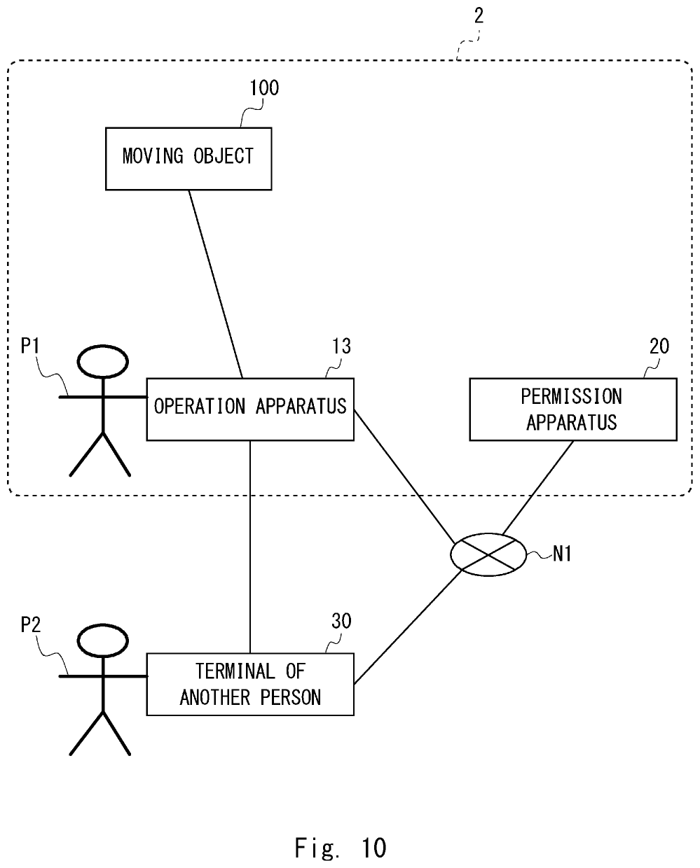

Next, a third example embodiment will be described. FIG. 10 is a system configuration diagram including an operation apparatus according to the third example embodiment. FIG. 10 illustrates an operation system 2 and the terminal 30 of the another person. The operation system 2 and the terminal 30 of the another person according to the present example embodiment are different from the above-described example embodiments in that both are connected to a network N1.

The operation system 2 according to the present example embodiment includes an operation apparatus 13 instead of the operation apparatus 12. Furthermore, the operation system 2 includes a permission apparatus 20 communicably connected to the operation apparatus 13 via the network N1. The operation apparatus 13 and the permission apparatus 20 are communicably connected to each other via the network N1. Note that the network N1 may be a telephone line, a wide area network, or a local area network.

In the operation system 2, the operation apparatus 13 can acquire permission information from the permission apparatus 20 via the network N1. In the operation system 2, the operation apparatus 13 can transmit the certification information to terminal 30 of the another person via the network N1. The terminal 30 of the another person can acquire the certification information transmitted from the operation apparatus 13 via the network N1. The terminal 30 of the another person is communicably connected to the permission apparatus 20, and can inquire of the permission apparatus 20 about the certification information received from the operation apparatus 13.

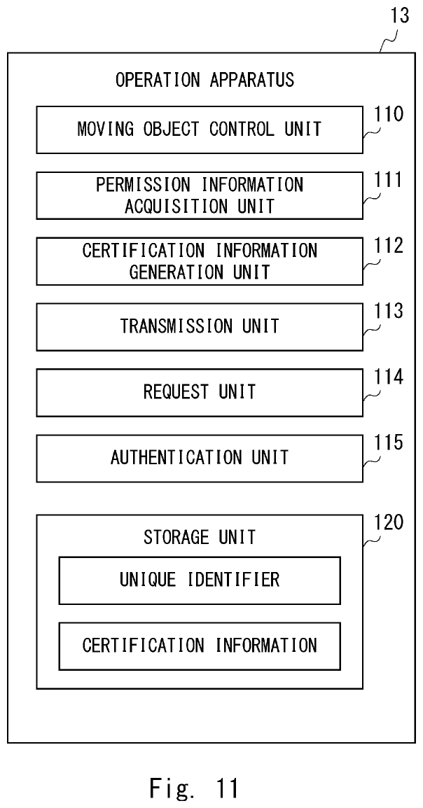

The operation apparatus 13 will be described with reference to FIG. 11. The operation apparatus 13 is different from the operation apparatus 12 described above in that the operation apparatus 13 further includes a request unit 114 and an authentication unit 115.

The request unit 114 requests the permission information from the permission apparatus 20. That is, for example, the operation apparatus 13 requests the permission apparatus 20 to issue the permission information by the operation of the operator P1. In this case, the permission information acquisition unit 111 acquires the permission information from the permission apparatus 20 as a response to the request.

The authentication unit 115 authenticates the operator P1. In this case, the authentication unit 115 authenticates the operator P1 by, for example, collating authentication information registered in advance with authentication information acquired by a predetermined operation. Note that, although the details of the authentication mechanism are omitted here, for example, the authentication unit 115 may register and store biological information of the operator P1 in advance. The biometric information is a fingerprint, an iris, a face image, or the like.

When the authentication by the authentication unit 115 is successful, the permission information acquisition unit 111 acquires the permission information from the permission apparatus 20. Meanwhile, when the authentication by the authentication unit 115 is not successful, the permission information acquisition unit 111 does not acquire the permission information from the permission apparatus 20.

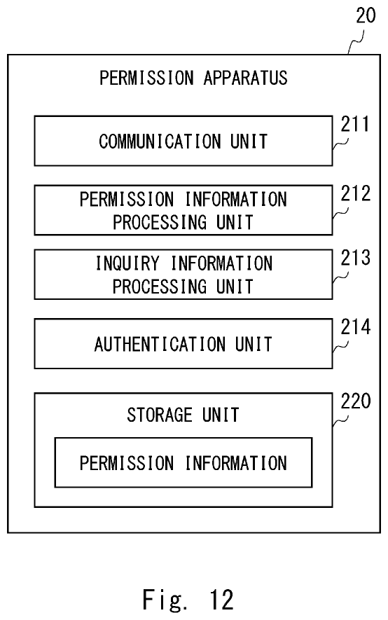

Next, the permission apparatus 20 will be described with reference to FIG. 12. FIG. 12 is a block diagram of a permission apparatus 20 according to the third example embodiment. The permission apparatus 20 mainly includes a communication unit 211, a permission information processing unit 212, an inquiry information processing unit 213, an authentication unit 214, and a storage unit 220.

The communication unit 211 is an interface for connecting to the network N1. When receiving predetermined information via the network N1, the communication unit 211 appropriately supplies the received information to each configuration of the permission apparatus 20. Meanwhile, when receiving predetermined information from each component of the permission apparatus 20, the communication unit 211 supplies the received information to the operation apparatus 13 and the terminal 30 of the another person via the network N1.

The permission information processing unit 212 receives a request signal related to issuance of the permission information from the operation apparatus 13, and supplies the permission information corresponding to the received request signal to the operation apparatus 13.

The inquiry information processing unit 213 collates the certification information supplied from the terminal 30 of the another person with the permission information stored in the storage unit 220, and determines the authenticity of the certification information. In a case where the authenticity determination of the certification information has been performed, the inquiry information processing unit 213 supplies a result of the determination to the terminal 30 of the another person.

Note that the terminal 30 of the another person according to the present example embodiment has a function of notifying a predetermined notification destination of the determination result according to the determination result when receiving the authenticity determination result from the permission apparatus 20. That is, for example, as a result of the inquiry by the permission apparatus 20, in a case where it is not recognized that the certification information issued by the operation apparatus 13 has been officially permitted, the terminal 30 of the another person can notify a predetermined regulatory agency such as police or an administrator (that is, a manager or the like) of information regarding the result. Here, the information regarding the above-described result may include, for example, information for specifying the operator, position information of the operation apparatus 13, and the like.

When issuing permission information for the request signal received from the operation apparatus 13, the authentication unit 214 authenticates the operator P1 related to the request signal or the operation apparatus 13 which is a transmission source of the request signal.

The storage unit 220 is a storage device including a non-volatile memory such as a solid state drive (SSD) or a flash memory. The storage unit 220 stores a plurality of pieces of permission information.

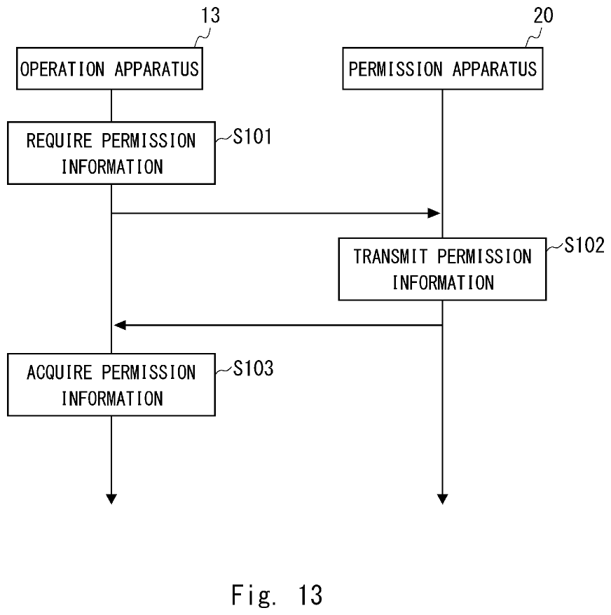

Next, processing performed by the operation apparatus 13 and the permission apparatus 20 will be described with reference to FIG. 13. FIG. 13 is a sequence diagram illustrating processing executed by the operation apparatus 13 and the permission apparatus 20 according to the third example embodiment.

First, the operation apparatus 13 requests the permission apparatus 20 to issue permission information related to the operation of the own device (Step S101).

Next, the permission apparatus 20 that has received the request from the operation apparatus 13 reads the permission information corresponding thereto from the storage unit 220, and transmits the read permission information to the operation apparatus 13 (Step S102).

Next, the operation apparatus 13 acquires the permission information from the permission apparatus 20 via the network N1 as a response to the above-described request (Step S103). Note that the processing after the operation apparatus 13 acquires the permission information is similar to the processing illustrated in FIG. 2.

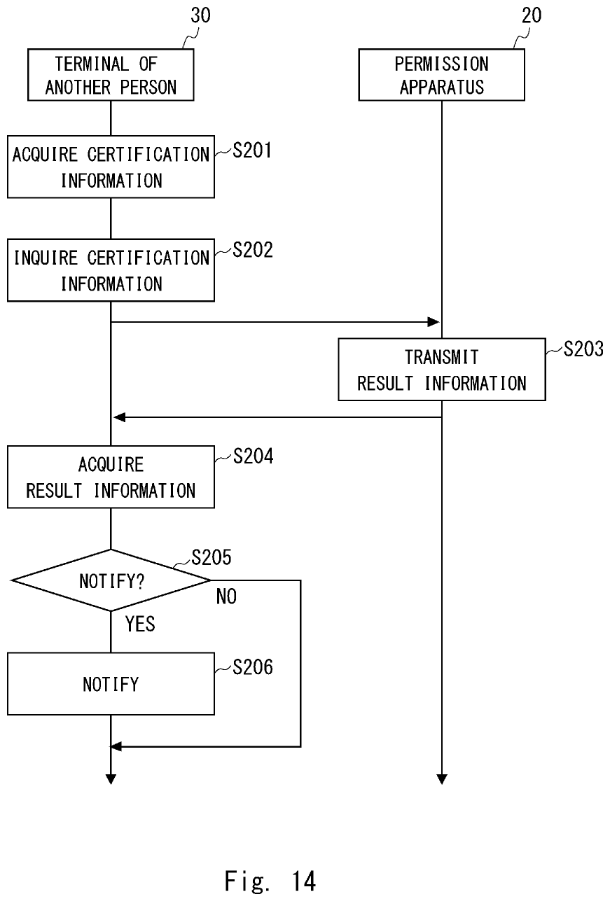

Next, processing performed by the terminal 30 of the another person and the permission apparatus 20 will be described with reference to FIG. 14. FIG. 14 is a sequence diagram illustrating processing executed by the operation apparatus and the terminal of the another person according to the third example embodiment. Note that it is assumed that the terminal 30 of the another person according to the present example embodiment has a program for inquiring the certification information. In addition, it is assumed that the terminal 30 of the another person according to the present example embodiment has a program for performing notification to a predetermined notification destination according to a result of acquired certification information.

First, the terminal 30 of the another person acquires the certification information transmitted by the operation apparatus 13 (Step S201). Next, the terminal 30 of the another person executes processing of inquiring the acquired certification information (Step S202). More specifically, for example, the terminal 30 of the another person supplies the inquiry information including the certification information to the permission apparatus 20 using a predetermined application program, and requests the inquiry regarding the certification information.

Next, upon receiving the inquiry information from the terminal 30 of the another person, the inquiry information processing unit 213 of the permission apparatus 20 collates the certification information included in the received inquiry information with the permission information stored in the storage unit 220, and transmits result information that is a result of the inquiry to the terminal 30 of the another person (Step S203). That is, the permission apparatus 20 determines whether or not to permit the operation with respect to the received inquiry information, and transmits the result of the determination to the terminal 30 of the another person as the result information.

Next, the terminal 30 of the another person acquires result information from the permission apparatus 20 (Step S204). Furthermore, the terminal 30 of the another person determines whether or not to notify the result information (Step S205). In a case where it is indicated in the result information that the inquired certification information is officially authorized, the terminal 30 of the another person does not perform notification. That is, in this case, the terminal 30 of the another person does not determine to perform notification. In this case (Step S205: NO), the terminal 30 of the another person does not make a notification and ends the processing. Meanwhile, in a case where the result information does not indicate that the inquired certification information is officially permitted, the terminal 30 of the another person makes a notification. In this case (Step S205: YES), the terminal 30 of the another person notifies the administrator or the like registered in advance that the certification information related to the operation that has not been officially permitted has been received (Step S206). After performing the above-described notification, the terminal 30 of the another person ends the series of processing.

The third example embodiment has been described above. According to the above configuration, the operation apparatus 13 can cause another person to suitably recognize that the moving object is operated with the permission. In addition, according to the above configuration, in a case where the moving object is not operated with formal permission, another person can recognize the fact and notify the administrator of the fact. Note that, in the above-described flowchart, in a case where the inquired certification information is not indicated to be officially permitted (Step S205: YES), the terminal 30 of the another person may have a function of causing the user P2 who is another person to determine or select whether or not to make a notification. In this case, in the terminal 30 of the another person, the display unit 314 displays a message prompting selection as to whether or not to make notification. Then, the operation reception unit 315 receives an operation related to selection performed by the user P2. In a case where the user P2 selects notification, the terminal 30 of the another person performs notification (Step S206). Meanwhile, in a case where the user P2 does not select notification, the terminal 30 of the another person ends the processing without performing notification.

As described above, according to the present example embodiment, it is possible to provide the operation apparatus and the like capable of objectively notifying that the moving object is officially operated.

<Example of Hardware Configuration>

Hereinafter, a case where each functional configuration of the determination device in the present disclosure is realized by a combination of hardware and software will be described.

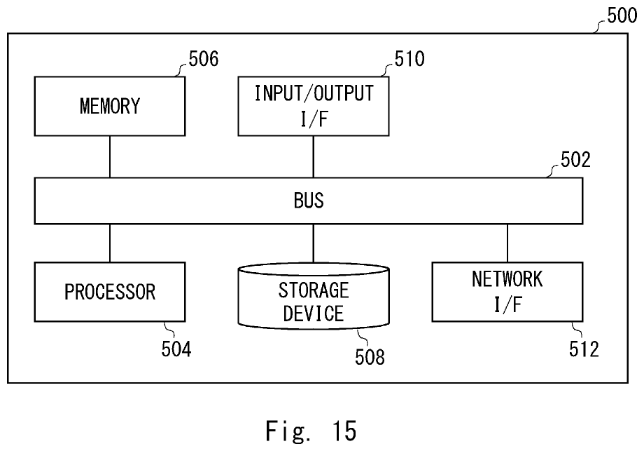

FIG. 15 is a block diagram illustrating a hardware configuration of a computer. A management device in the present disclosure can realize the above-described functions by a computer 500 including the hardware configuration illustrated in the drawings. The computer 500 may be a portable computer such as a smartphone or a tablet terminal, or may be a stationary computer such as a PC. The computer 500 may be a dedicated computer designed to realize each device, or may be a general-purpose computer. The computer 500 can realize a desired function by installing a predetermined program.

The computer 500 includes a bus 502, a processor 504, a memory 506, a storage device 508, an input/output interface 510 (an interface is also referred to as an interface (I/F)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a CPU, a GPU, or an FPGA. The memory 506 is a main storage device realized by using a random access memory (RAM) or the like.

The storage device 508 is an auxiliary storage device realized by using a hard disk, an SSD, a memory card, a read only memory (ROM), or the like. The storage device 508 stores a program for realizing a desired function. The processor 504 reads the program into the memory 506 and executes the program to implement each functional component of each device.

The input/output interface 510 is an interface for connecting the computer 500 and an input/output device. For example, an input device such as a keyboard or an output device such as a display device are connected to the input/output interface 510.

The network interface 512 is an interface for connecting the computer 500 to a network.

Although the example of the hardware configuration in the present disclosure has been described above, the above-described example embodiment is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals.

Although the disclosure of the present application has been described above with reference to the example embodiments, the disclosure of the present application is not limited to the above. Various modifications that can be understood by those skilled in the art can be made to the configuration and details of the present disclosure within the scope of the disclosure.

Some or all of the above example embodiments may be described as the following supplementary notes, but are not limited to the following.

### (Supplementary Note 1)

An operation apparatus including:
a permission information acquisition unit configured to acquires permission information indicating that an operator is permitted to operate a predetermined moving object;
a certification information generation unit configured to generate certification information based on the received permission information and information for specifying the operator; and
a transmission unit configured to transmit the certification information so as to be recognizable by another person via a predetermined communication line.

### (Supplementary Note 2)

The operation apparatus according to Supplementary Note 1, in which the permission information acquisition unit acquires the permission information including at least one of a time and a place of the operation related to the permission.

### (Supplementary Note 3)

The operation apparatus according to Supplementary Note 1, in which the certification information generation unit generates the certification information including a unique identifier of an own device.

### (Supplementary Note 4)

The operation apparatus according to Supplementary Note 1, in which the certification information generation unit generates the certification information including position information of an own device.

### (Supplementary Note 5)

The operation apparatus according to Supplementary Note 1, in which
the transmission unit transmits the certification information related to the permission within a time when the permission of the operation is received, and
suppresses the transmission of the certification information related to the permission outside the time when the permission of the operation is received.

### (Supplementary Note 6)

The operation apparatus according to any one of Supplementary Notes 1 to 5, further including a request unit configured to request the permission information to a permission apparatus configured to issue the permission information,
in which the permission information acquisition unit acquires the permission information as a response to the request.

### (Supplementary Note 7)

The operation apparatus according to Supplementary Note 6, further including an authentication unit configured to authenticate the operator,
in which the permission information acquisition unit acquires the permission information when the authentication is successful.

### (Supplementary Note 8)

The operation apparatus according to any one of Supplementary Notes 1 to 5, in which the transmission unit directly transmits the certification information to a terminal possessed by the another person as the communication line.

### (Supplementary Note 9)

An operation method executed by an operation apparatus of an operator who operates a predetermined moving object, the operation method including:
acquiring permission information indicating that permission is obtained for operating the moving object;
generating certification information based on the received permission information and information for specifying the operator; and
transmitting the certification information so as to be recognizable by another person via a predetermined communication line.

### (Supplementary Note 10)

A program causing a computer to execute an operation method including:
acquiring to acquires permission information indicating that an operator is permitted to operate a predetermined moving object;
generating certification information based on the received permission information and information for specifying the operator; and
transmitting the certification information so as to be recognizable by another person via a predetermined communication line.

### (Supplementary Note 11)

The operation method according to Supplementary Note 9, in which a terminal of the another person
receives the certification information,
inquires of a predetermined permission apparatus for inquiry information based on the received certification information, and
receives result information of the inquiry from the permission apparatus.

### (Supplementary Note 12)

The operation method according to Supplementary Note 11, in which the terminal of the another person associates a position of the operation apparatus with a posture of the terminal of the another person to display the position of the operation apparatus and the result information on an image display unit included in the terminal of the another person.

### (Supplementary Note 13)

The operation method according to Supplementary Note 12, in which the terminal of the another person displays, on the image display unit, an image obtained by photographing a landscape in a direction in which the terminal of the another person is present and the position of the operation apparatus in a superimposed manner.

### (Supplementary Note 14)

The operation method according to any one of Supplementary Notes 11 to 13, in which the permission apparatus determines whether or not to permit the operation based on the inquiry information, and transmits a result of the determination to the terminal of the another person as the result information.

### (Supplementary Note 15)

The operation method according to Supplementary Note 14, in which when the result information does not indicate that the operation is permitted, the terminal of the another person notifies a predetermined administrator of information regarding the operation apparatus.

What is claimed is:

1. An operation apparatus comprising:
a permission information acquisition unit configured to acquires permission information indicating that an operator is permitted to operate a predetermined moving object;
a certification information generation unit configured to generate certification information based on the received permission information and information for specifying the operator; and
a transmission unit configured to transmit the certification information so as to be recognizable by another via a predetermined communication line.

2. The operation apparatus according to claim 1, wherein the permission information acquisition unit acquires the permission information including at least one of a time and a place of the operation related to the permission.

3. The operation apparatus according to claim 1, wherein the certification information generation unit generates the certification information including a unique identifier of an own device.

4. The operation apparatus according to claim 1, wherein the certification information generation unit generates the certification information including position information of an own device.

5. The operation apparatus according to claim 1, wherein
the transmission unit transmits the certification information related to the permission within a time when the permission of the operation is received, and
suppresses the transmission of the certification information related to the permission outside the time when the permission of the operation is received.

6. The operation apparatus according to claim 1, further comprising a request unit configured to request the permission information to a permission apparatus configured to issue the permission information,
wherein the permission information acquisition unit acquires the permission information as a response to the request.

7. The operation apparatus according to claim 6, further comprising an authentication unit configured to authenticate the operator,
wherein the permission information acquisition unit acquires the permission information when the authentication is successful.

8. The operation apparatus according to claim 1, wherein the transmission unit directly transmits the certification information to a terminal possessed by the another person as the communication line.

9. An operation method executed by an operation apparatus of an operator who operates a predetermined moving object, the operation method comprising:
acquiring permission information indicating that permission is obtained for operating the moving object;
generating certification information based on the received permission information and information for specifying the operator; and
transmitting the certification information so as to be recognizable by another person via a predetermined communication line.

10. A non-transitory computer-readable medium having a program stored thereon, the computer-readable medium causing a computer to execute an operation method comprising:
acquiring to acquires permission information indicating that an operator is permitted to operate a predetermined moving object;
generating certification information based on the received permission information and information for specifying the operator; and
transmitting the certification information so as to be recognizable by another person via a predetermined communication line.

11. The operation method according to claim 9, wherein the acquiring of the permission information includes acquiring the permission information including at least one of a time and a place of the operation related to the permission.

12. The operation method according to claim 9, wherein the generating of the certification information includes generating the certification information including a unique identifier of an own device.

13. The operation method according to claim 9, wherein the generating of the certification information includes generating the certification information including position information of an own device.

14. The operation method according to claim 9, wherein
the transmitting includes transmitting the certification information related to the permission within a time when the permission of the operation is received, and
suppressing the transmission of the certification information related to the permission outside the time when the permission of the operation is received.

15. The operation method according to claim 9, further executing requesting of the permission information to a permission apparatus configured to issue the permission information,
wherein the acquiring of the permission information includes acquiring the permission information as a response to a request.

16. The non-transitory computer-readable medium of claim 10, wherein the acquiring of the permission information includes acquiring the permission information including at least one of a time and a place of the operation related to the permission.

17. The non-transitory computer-readable medium of claim 10, wherein the generating of the certification information includes generating the certification information including a unique identifier of an own device.

18. The non-transitory computer-readable medium of claim 10, wherein the generating of the certification information includes generating the certification information including position information of an own device.

19. The non-transitory computer-readable medium of claim 10, wherein
the transmitting includes transmitting the certification information related to the permission within a time when the permission of the operation is received, and
suppressing the transmission of the certification information related to the permission outside the time when the permission of the operation is received.

20. The non-transitory computer-readable medium of claim 10, further executing requesting of the permission information to a permission apparatus configured to issue the permission information,
wherein the acquiring of the permission information includes acquiring the permission information as a response to a request.
